(19) United States
(12) Patent Application Publication
(10) Pub. No.: US 2008/0178081 A1
(43) Pub. Date: Jul. 24, 2008

(54) SYSTEM AND METHOD FOR GUIDING NON-TECHNICAL PEOPLE IN USING WEB SERVICES

(76) Inventors: Eran Reshef, Tel Aviv (IL); Amir Hirsh, Tel Aviv (IL)

Correspondence Address: DREIER LLP, 499 PARK AVE, NEW YORK, NY, 10022, US

(21) Appl. No.: 12/017,653

(22) Filed: Jan. 22, 2008

Related U.S. Application Data
(60) Provisional application No. 60/886,040, filed on Jan. 22, 2007.

(51) Int. Cl. G06F 3/00

(52) U.S. Cl. 715/700

(57) ABSTRACT

The method and system for guiding a user to operate simplified computing operations for common web services activities via a web service interface standard to the web service itself include recognizing a user's activity with the web service. The method and system includes providing a first interface to the user for performing an operation relating to the web service, where the first interface is different from the web service interface associated with the web service and the first interface includes a plurality of graphical elements. In the method and system, upon receiving the user input commands via the first interface, the user input commands are translated into a format usable by the web service and provided to the web service, bypassing existing web service input commands provided by the web service interface.

### PRIORITY CLAIM

This application is claims the benefit of U.S. Provisional Application No. 60/886,040, entitled “SYSTEM AND METHOD FOR GUIDING NON-TECHNICAL PEOPLE IN USING WEB SERVICES,” filed on Jan. 22, 2007, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention is directed to computer networks, and more particularly to a system and method for guiding non-technical people in using web services.

### BACKGROUND OF THE INVENTION

The term “Web 2.0” refers to a perceived or proposed second generation of Internet-based services such as social networking sites. The term coined by O'Reilly Media in 2004 has given a name to a recent phenomenon wherein next generation “Web2.0” sites began to flourish. In the new era of Web2.0, the existing mega-sites slowly dissipate and their combined content is being broken down and regrown within a multitude of new niche websites. The Web2.0 scene is simply bursting with new initiatives and still new ones keep emerging each and every day.

Within this new reality, a person can indulge in his niche hobbies with a thriving online society from around the world, sharing the same interests. As every user has his own usage habits, today's website user interface (UI) will quite frequently require more than a few mouse clicks to allow a person to accomplish his own personalized web site browsing. Hence, to accommodate all his interests online, a person will need to specialize in using a plethora of websites, each with its own distinct user interface, quirks and frequent changes.

The Web2.0 era websites strive to offer their users a personalized experience. To accomplish personalization and to offer security and privacy, the vast majority of Web2.0 web sites require the creation of personal accounts, confirming the registration and login to the service before starting to use it—a process the user will need to repeat, manually, for every website he wishes to use. The user will also need to manually keep track of his registration details for each website and update them all manually if a change in his personal details is required.

In today's websites, it is easy for a friend to direct you to a web page with content he believes you'll find interesting. It is unfortunately quite a different task to direct a friend to perform an action in one of those websites. The websites seldom introduces a single link that when clicked will make you vote for the best photo, ask a website moderator to remove an offending article or post a positive comment on an interesting essay. If he wants you to participate, your friend will probably need to provide you with textual step-by-step instructions on how to accomplish such tasks.

Web2.0 websites tend to borrow ideas from each other's UI and features. While this makes it quite straightforward for a tech-savvy user to dive into new Web2.0 sites, the growing multitude of know-how prerequisites often makes it quite intimidating for the less technical users to join websites that otherwise would have offered them a wealth of information and a place to express themselves.

### BRIEF SUMMARY OF THE INVENTION

We provide a method and system for guiding users, such as non-technical people, in using web services. Methodologies and/or techniques are included to simplify the use of commonly required website operations; automatically bypassing website complications; automating the manual and repetitive nature of personal details input across websites; and self management of all personal user details at a single location.

The invention helps simplify operations such as registration to web site services, logging in with the registration details and using all site specific features, such as commenting on a news item, voting in a poll and rating articles.

The method and system for guiding a user to operate simplified computing operations for common web services activities via a web service interface standard to the web service itself include recognizing a user's activity with the web service. The method and system includes providing a first interface to the user for performing an operation relating to the web service, where the first interface is different from the web service interface associated with the web service and the first interface includes a plurality of graphical elements. In the method and system, upon receiving the user input commands via the first interface, the user input commands are translated into a format usable by the web service and provided to the web service, bypassing existing web service input commands provided by the web service interface. The web service performs an operation based on the translated input commands and generates an output, which is provided back to the first interface. The output commands are then translated for display on the first interface.

One type of simplification includes the introduction of new user interface and graphical elements, side-by-side with the existing website interface, or external to the existing interface. Such elements may include a graphical overlay that marks actions the user needs to take for a required operation to be activated (clicking a button, following a link, clicking a graphical element, moving a slider, etc.) by darkening the screen except for the location of the action UI, highlighting the action UI itself and/or overlaying a graphical pointer that points to the action UI.

Another example of such elements may include new alternative UI elements (buttons, links, forms, etc.) placed at a more graphically visible location, that when activated perform the required actions instead of the available UI elements. This may include, for example, a new, large button at the top of the page that when clicked will perform the same operation as clicking a small link at the bottom of the original website page.

Another such element is a graphical wizard with rich documentation (e.g. text, photos, videos) to guide the user step-by-step through the required actions or alternatively, textual, audio or video instructions to guide the user step-by-step through the required actions.

The invention includes methods to automatically bypass common website complications by, for example, the complication of choosing a user name that is unique in this web service, coming up with a strong yet memorable password and automatically confirming registration requests by receiving the confirmation email and following the confirmation link within.

A method is provided to automate manual repetitive tasks required across websites, such as retyping personal details including a name, date of birth, home address, etc. Example of automation and simplification includes showing an alternative, common graphical interface to ask the user for personal details, keeping store of the personal details and using it automatically in future web sites when reuse of such data is possible. Another method of automation includes the automatic deduction of user information when possible, for example, deducing a geographical address from the user's Internet IP address information. A system is also provided to allow the user to manage his personal details at a single location.

Another method is provided to simplify complex operations within or across websites by chaining common actions into a single new action. The new action could perform multiple actions on a single web site, for example register the user to a web site, log in to it, browse to a poll page within the web site and vote in the poll. The new action could perform multiple actions on multiple web sites, such as posting the same comment in several blogs when the blogs cover the same issue to which the comment is relevant. The new action could also perform related actions on multiple web sites, such as uploading the currently viewed photo on Flickr to my MySpace account and adding a blog item in Blogger about the new photo.

The invention includes a Web Assistant Manager that is responsible for the knowledge of what web site is supported and that combines the data from an Automation Repository, a Context UI Repository, and a Personal Data Manager to provide computerized instructions for creating a new, better personalized, simpler and more usable web site interface.

The alternative web site interface is offered to the user through a Display Proxy that applies the above instructions on the existing web site interface to create a new, simpler usage experience.

The system may be provided via a server-side computer-implemented method that does not require the user to install additional applications, or alternatively, a client-side computer-implemented method that requires the user to install an additional application(s).

The invention includes a mechanism for gathering common statistics on the system users' behavior while supplying them to the system administrator in a concise way.

Other business models and technical aspects would become apparent to those skilled in the relevant art(s) in view of the teachings of the present disclosure. Additional aspects of the present invention would be apparent in view of the description that follows.

### BRIEF DESCRIPTION OF THE DRAWINGS

The foregoing and other aspects of the invention will become more apparent from the following description of illustrative embodiments thereof and the accompanying drawings, which illustrate, by way of example, the principles of the invention. In the drawings:

FIG. 1 a illustrates the system in a server-side deployment configuration;

FIG. 1b illustrates the system in a client-side deployment configuration;

FIG. 2 illustrates the components of the system and its internal data flow;

FIG. 3 a-f illustrate a usage example of the assistant service; and

FIG. 4 illustrates a flowchart of the steps of one embodiment of a method for guiding a user to operate simplified computing operations for common web services activities.

### DETAILED DESCRIPTION OF ILLUSTRATIVE EMBODIMENTS

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

### Overview of the System

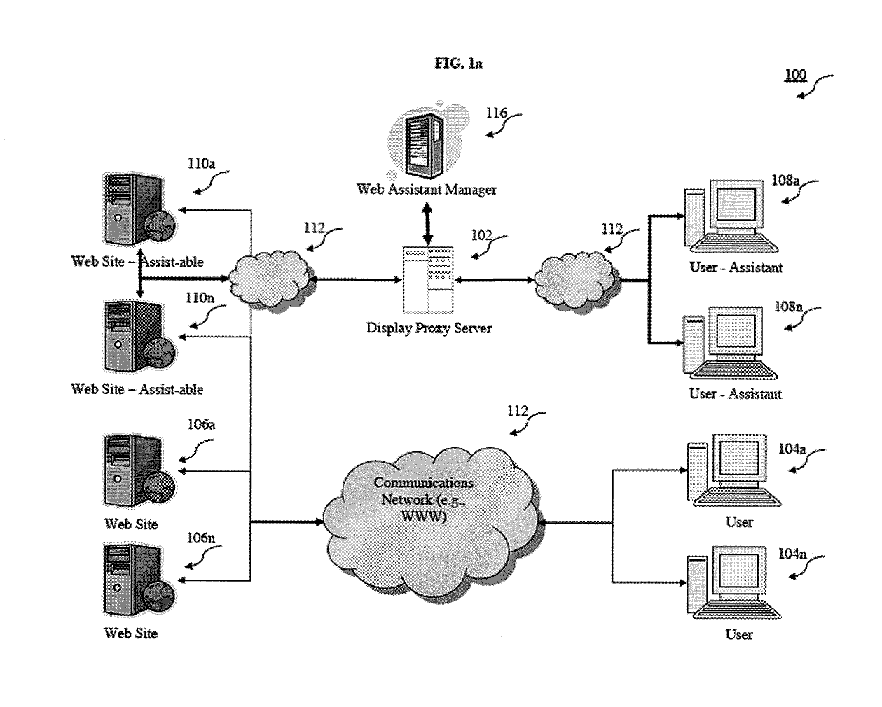

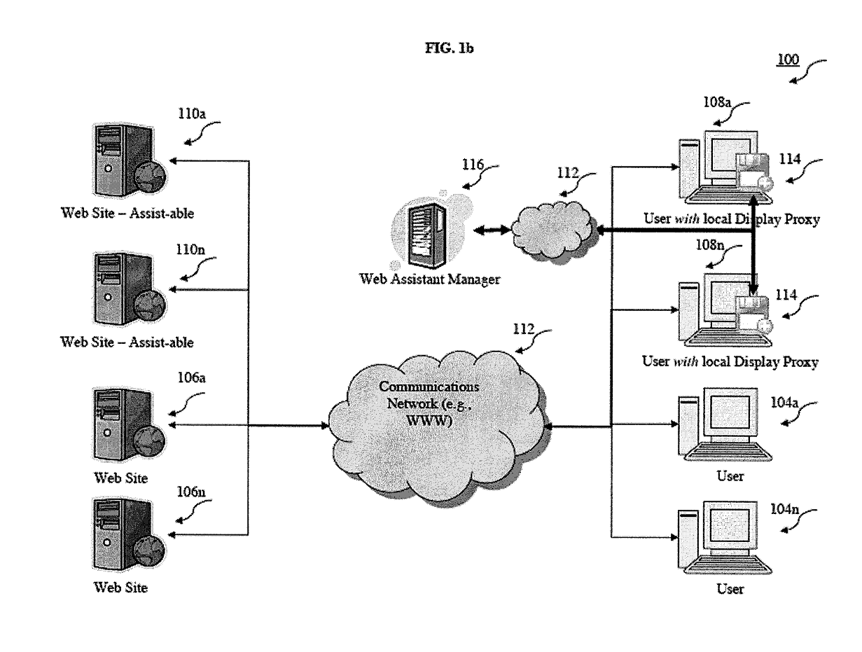

FIGS. 1a and 1b illustrates a system 100 for guiding users, non-technical people, in using web services. FIG. 1a illustrates the system in a server-side configuration and FIG. 1b illustrates the system in client-side configuration.

FIGS. 1a and 1b illustrate a plurality of Users 108a-108n that use the system, a plurality of Web Sites 110a-110n that are supported by the system such that the Users can be assisted through using the services on these web sites. The systems in FIGS. 1a and 1b include a plurality of websites 106a-106n that are not supported by the system, a Display Proxy Engine 102/114 that can route internet content and change it to include new UI behavior and actions and a Web Assistant Manager 116 that determines the enhancements and actions that are supported for each Web Site and the method to apply them, and a communication network 112.

In FIG. 1a, the Display Proxy Engine 102 is a server, separated from the user's machine and communication between the latter is via a communications network 112. In FIG. 1b, the Display Proxy Engine 114 is a locally installed application that resides on the user's own machine.

As explained in greater detail below, the Web Assistant Manager 116 guides the Users through their web browsing experience by, for example, using the Display Proxy Engine 102 to alter and simplify the user interface of existing web sites. For example, Users 108a-108n may browse a supported website that requires an initial registration. The system will detect the supported web site and the required registration and will supply an immediate alternative interface for the registration action. The new registration interface will take into consideration values from historically used registration forms such as a preferred username, password and email, and will require the user to acknowledge the registration by no more than a single click of an approval button.

A Web Assistant Manager 116 can be implemented via one or more servers, with each server being one or more computers providing various shared resources with each other and to other system components. The shared resources include files for programs, web pages, databases and libraries; output devices, such as, printers, plotters, display monitors and facsimile machines; communications devices, such as modems and Internet access facilities; and other peripherals such as scanners, or the like. The communications devices can support wired or wireless communications, including satellite, terrestrial (fiber optic, copper, coaxial, and the like), radio, microwave, free-space optics, and/or any other form or method of transmission.

The server hosting a Web Assistant Manager 116 can be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

Communications network 112 provides a transmission medium for communicating among the system components. Communications network 112 includes a wired and/or wireless local area network (LAN), wide area network (WAN), or metropolitan area network (MAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 112 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

### System Architecture Overview

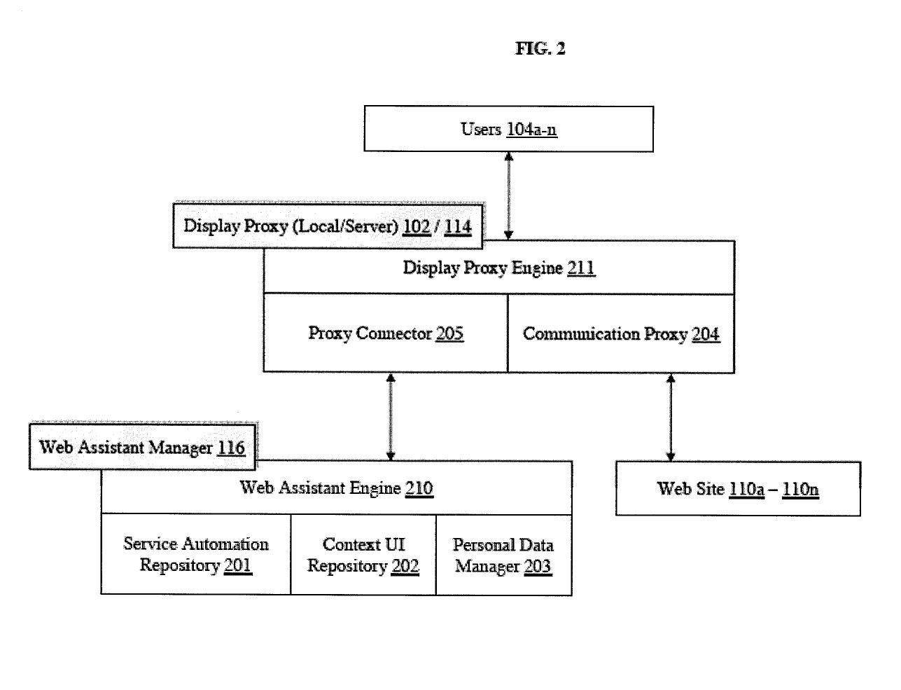

FIG. 2 illustrates an embodiment of the system. However, the present invention is not implicitly or explicitly limited to such a embodiment, and various alternative models and organizations would become apparent to those skilled in the relevant art(s) after being taught by the present example. The components of FIG. 2 can be implemented using a combination of computer hardware, firmware, and software, using engineering design techniques and network protocols that are guided by the principles of the present invention as would become apparent from the detailed descriptions herein. For example, all components can be implemented as software components running on top of standard personal computers running the Windows® operating systems available from Microsoft Corporation (Redmond, Wash.).

FIG. 2 illustrates the components of a Web Assistant Manager 116, including Web Assistant Engine 210, Service Automation Repository 201, Context UI Repository 202 and Personal Data Manager 203. The figure also illustrates the components of Display Proxy (Local/Server) 102/114, including Display Proxy Engine 211, Proxy Connector 205 and Communication Proxy 204.

The Web Assistant Manager 116 is responsible for the knowledge of which web site is supported by the system and for the process of combining data from the Context UI Repository 202, the Automation Repository 201 and the Personal Data Manager 203 to an alternative web site interface building instructions.

The Web Assistant Engine 210 is a facade for the Web Assistant Manager and is responsible for managing the Web Assistant Application Programming Interface (API) and for synchronizing the activities of the other Web Assistant Manager subcomponents.

The Service Automation Repository 201 contains a list of supported web services together with API created to support those services. These APIs can be used to activate actions supplied by these services.

The Context UI Repository 202 contains alternative, possibly personalized user interfaces for the various supported web sites.

The Personal Data Manager 203 manages all known users' personal data, including account details, preferred user names, passwords, address, etc. For security reasons, the actual personal data may reside on the user's computer as a web browser cookie or encoded on the server, decoded with a key available only to the user, upon request. The Web Assistant Manager 116 may use the Personal Data Manager 203 to automatically deduce registration details for new websites based on such previously used data. The User may also use the Personal Data Manager to manage his existing personal data, change it or delete it altogether.

The Display Proxy 102/114 is responsible for fetching the original web site request and for taking the Web Assistant Manager's alternative interface instructions, combining the two to create a new, simpler usage experience.

The Display Proxy Engine 211 is a facade for the Display Proxy and is responsible for managing the Display Proxy API and for synchronizing the activities of the other Display Proxy subcomponents.

The Communication Proxy 204 can fetch general web sites over the Communication's network 112, activate a transformation on the data and proxy it back to the User.

The Proxy Connector 205 receives an original web site and the Web Assistant Manager's alternative interface instructions. It is responsible for combining the two to create a new, simpler usage experience.

In FIG. 2 a plurality of Users 114a-114n are assisted in using their web services by routing their original Web Site 110a-110n content through the Display Proxy 102/114. The Display Proxy contacts the Web Assistant Manager 116 that uses the Service Automation Repository 201, the The Context UI Repository 202 and The Personal Data Manager 203 to determine what enhancements and actions are supported for each of the specific Web Sites 110. The Web Assistant Manager 116 communicates the actual new actions, UI elements and instructions on how to combine or integrate them for use with the original Web Site 110 back to the Display Proxy 102/114. The Display Proxy 102/114 then uses the The Proxy Connector 205 to combine the new interface with the original web site and the The Communication Proxy 204 to return the enhanced web site back to the User's local web browser, desktop application, etc. This combination may be via an overlay or any other suitable type of programming technique whereby an input command is received on the first interface, translated to language or instructions understandable by the receiving web site.

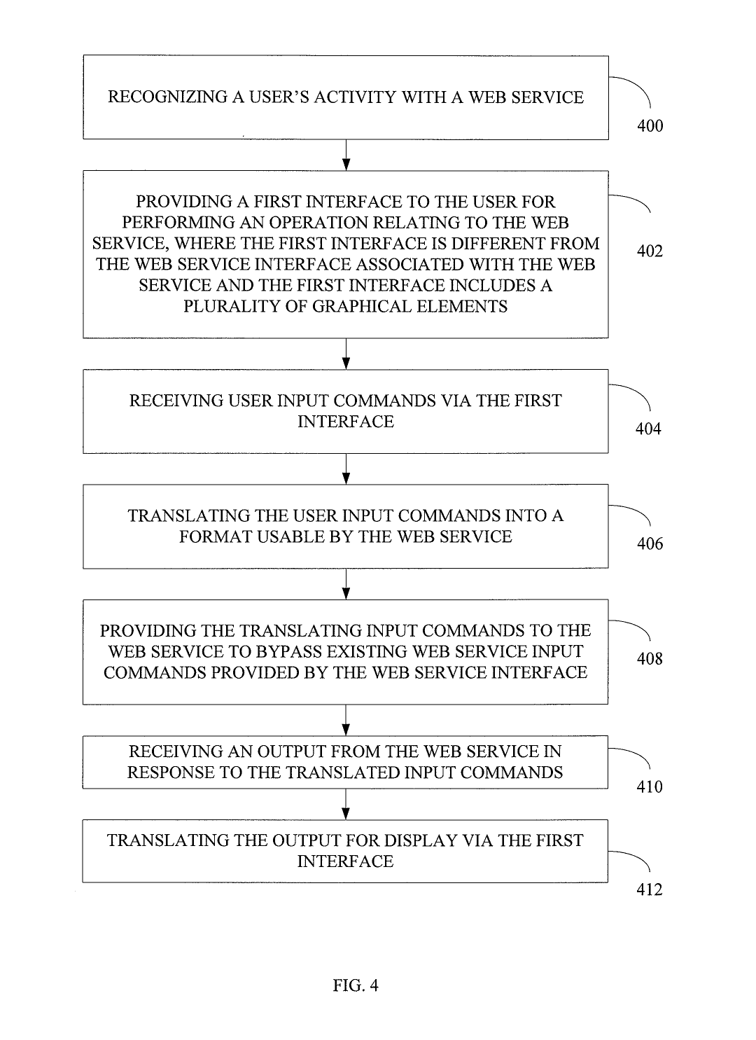

As described below with respect to FIG. 4, there are additional embodiments that include additional functionality, as operative to be performed by the processing devices of FIGS. 1 and 2.

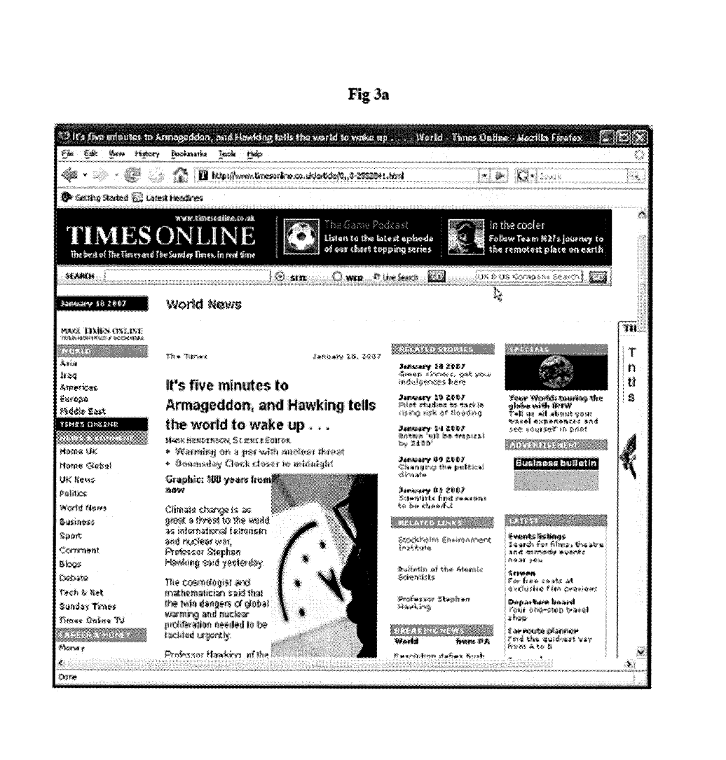

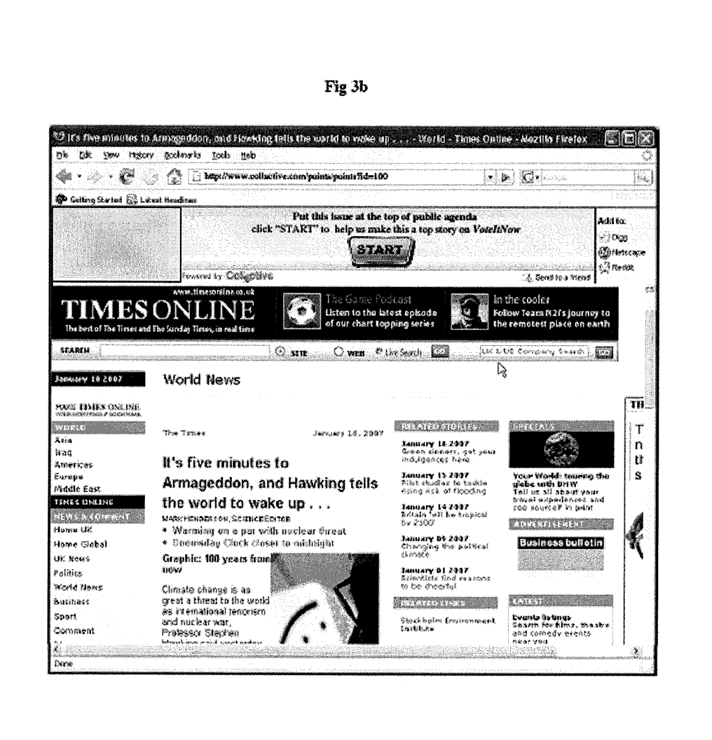

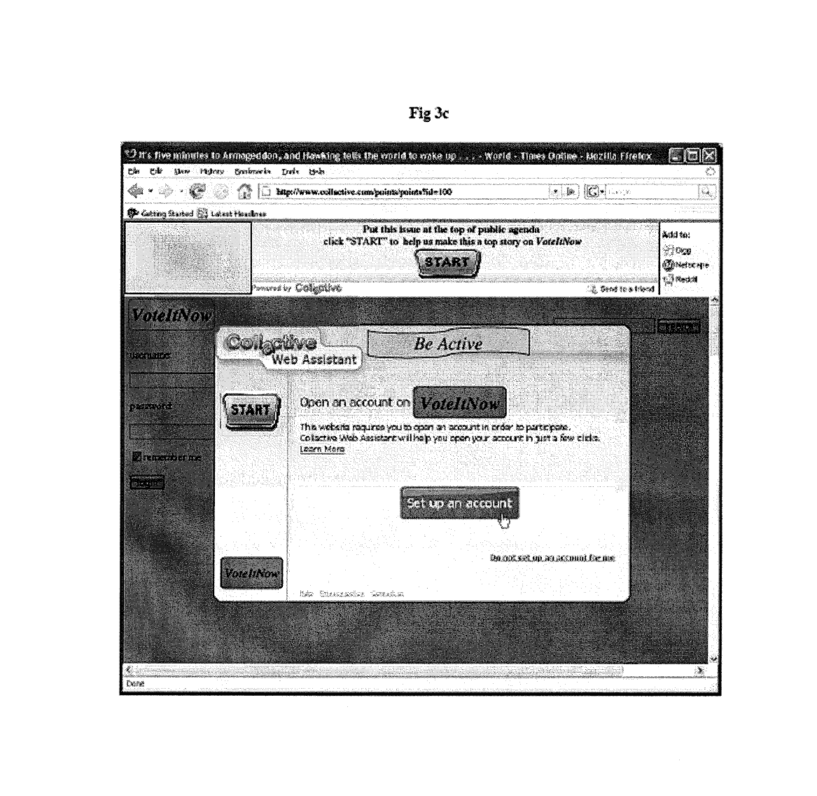

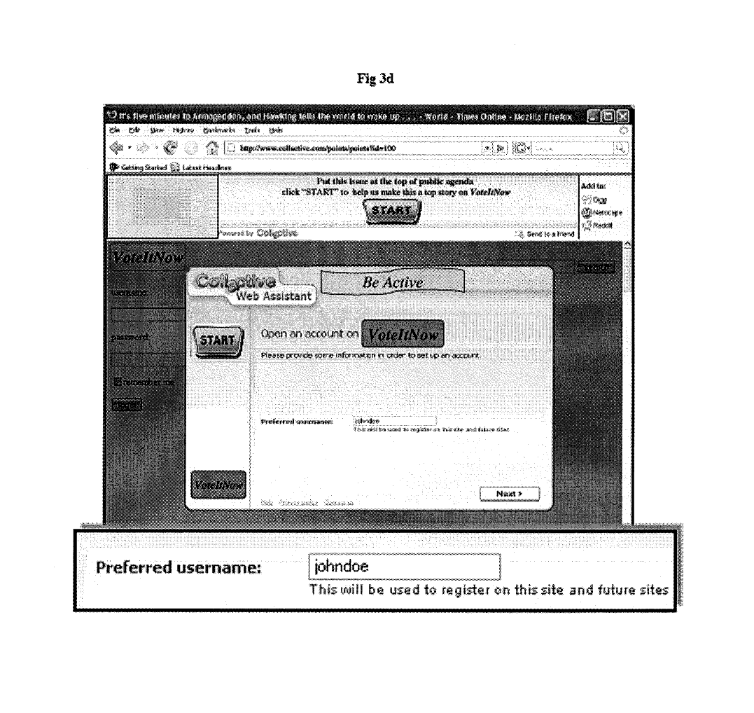

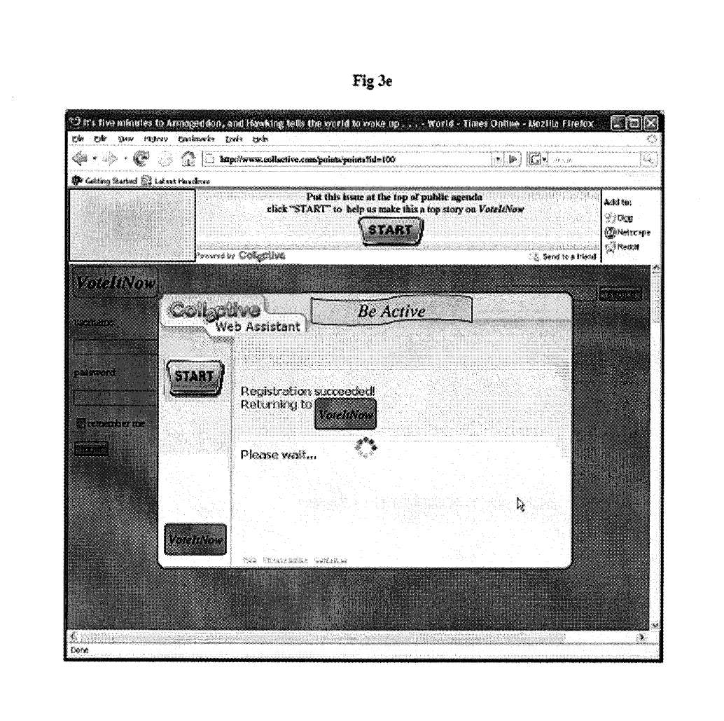

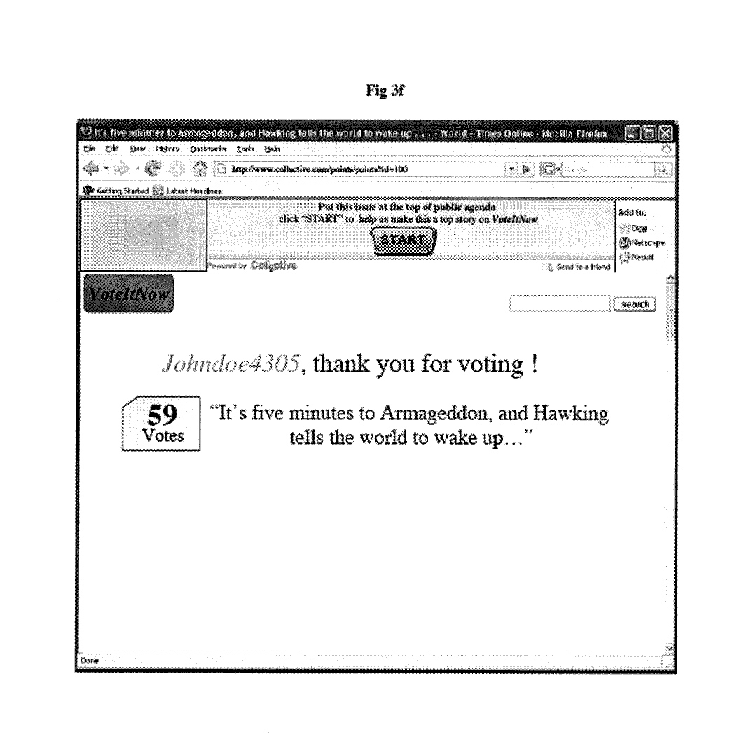

FIG. 3a-f illustrates an example of the user experience of using the system 100 for guidance in using web services. This sample screenshots represent exemplary output displays viewable by a user using the described invention. The sample screenshots also represent exemplary output displays generated by the described invention.

FIG. 3a illustrates an online newspaper article that is of interest to a community of environmentally-aware users. A community moderator may wish to inform community members about this article and ask them to contact the exemplary social linking website VoteItNow to promote this article through voting. By contrast, without the system, the manager would probably resort to sending a pleading email with elaborate textual instructions on how to access the site, perform a registration and vote for the article.

FIG. 3b illustrates the same online newspaper article, enhanced with a simplified VoteItNow interface. The interface includes simple textual overview and a single “Start” button.

FIG. 3c shows the web browser after a user clicked the “Start” button. The button directed the VoteItNow website content via the Display Proxy 102 in its server-based configuration. The proxy contacted the Web Assistant Manager 116 that in turn detected that the user is not registered to the VoteItNow service and now offers a new wizard user interface to quickly setup a new VoteItNow account.

In FIG. 3d, the user clicked the “Set up an account” button. The Web Assistant Manager identifies that the user hadn't previously mentioned any preferred “username” to be used in website registrations. The Web Assistant Manager asks the user via the Display Proxy for such a preferred name. In this case, the user asks to use the name “johndoe” and then clicks “next”.

In FIG. 3e, the system informs the user that it completed his semi-automatic registration. This semi-automatic registration may include accessing a local cache or other storage device to retrieve various amounts of information. Additional techniques can include having a user enter information in a one-time form and that form is then accessed, whereby appropriate information is retrieved and inserted into the registration form. These registrations may include text or character recognition to recognize the requested content for various data entry fields or the entry form including meta data usable to distinguish which user-data information to dispose in the various form fields.

In FIG. 3f, after the registration completed successfully, the Web Assistant Manager continues with the original chain of actions and forwards the user to the original article link within the VoteItNow service. Without requiring the user's intervention, the system continues and vote positively for the story. Notice the highlighted user name “johndoe4305”, generated automatically after the system detected that a user with the name “johndoe” already exists. In accordance with functionality in response to executable instructions, all of these actions originate with just a single click of the Web Assistant Manager's “Start” button.

FIG. 4 illustrates a flowchart of the steps of one embodiment of a method for guiding a user to operate simplified computing operations for common web services activities via a web service interface standard to the web service itself.

In one embodiment, a first step, step 400, is recognizing a user's activity with the web service. This step may be performed in any number of suitable manners, including an active application monitoring user activity and recognizing various activities, such as based on data interchanges/requests, e.g. such as retrieving a particular web URL, or in another example having an active overlay to recognize cursor or display activities relatives to various fields, such as for example recognizing that a user has entered a data entry field and based on the position of this field, recognizing the data entry field, for example a login field.

A next step, step 402, is providing a first interface to the user for performing an operation relating to the web service, where the first interface is different from the web service interface associated with the web service and the first interface include a plurality of graphical elements. By way of example, FIGS. 3a-f above illustrate various exemplary screenshots of sample overlays of the first interface relative to the native interface for the underlying web service. This step may be performed by launching an application or routine on a processing device which thereupon overlays the first interface for viewing and usage by the user. This overlay includes additional back-end processing operations relating to recognizing user activities and providing additional level of interactivity and functionality based on these user actions.

In one embodiment, another step, step 404, is receiving user input commands via the first interface. As described above, these user input commands may be via a tactile interface, such as the example of a mouse or keyboard. The user enters the commands using common input techniques, such as clicking on a mouse button or depressing various keys on the keyboard, whereby the processing operations in the computing device recognize these inputs as being on the first interface.

A next step, step 406, is translating the user input commands into a format usable by the web service. This translation may include processing operations that recognize the user input received in step 404 and then referencing a proper input command for the web service interface. For example, one embodiment of translation may include rewriting the input code based on programming parameters, another embodiment may include a look-up table or other type of reference to convert the first interface command into a command usable by the web service. It is recognized that this typically uses web services having predefined input commands, or may utilize a particular interface having generalized or uniform input techniques.

In this methodology, a next step, step 408, is providing the translated input commands to the web service to bypass existing web service input commands provided by the web service interface. The step may include providing the translating input commands directly to the processing component operating the web service, or in another embodiment may include a script or other type of automated operation to cause the translated commands to be entered directly into the web service interface. Regardless of the specific technique or embodiment, the user enters input information via the first interface, where the first interface is a user friendly interface, and the input in then provided directly to the web service, accordingly guiding the user to operate simplified computing operations for common web service activities.

Another step may include step 410, where the computer-implemented method includes receiving an output from the web service in response to the translated input commands. In step 412, the method may further include translating the output for display via the first interface, such that the user is presented with additional interactivity in the web service via the first interface. It is further noted that this methodology may be performed by a centrally located device, such as for example on a web server or may also be locally performed, such as an application running on a local processing device.

Additional embodiments are recognized using the above-noted methodology, as may be implemented in the above-described computing environment. For example, another embodiment may include the recognition of repetitive input commands to the web service interface, translating the input information for a generalized input command usable with the first interface and providing the generalized input command in place of the repetitive input command. This operation may be beneficial to assist users from cumbersome repetitive tasks, such as for example having to login to a large number of websites.

Another embodiment in the first interface may include darkening portions of the overlay directly over the web service interface such that un-darkened portions illustrate selectable interface components to be selected by the user. The first interface may also include displaying a new selectable visual component for user selection instead of the existing visual components in the web service interface. An example may be the display of a large “enter” button for the user to select upon entering information, which could alleviate a user having to search the web service interface for the native enter command bar.

Another embodiment may include the first interface including a graphical overlay of one or more video elements providing direct visual instructions for the user to perform steps for interacting with the underlying web service interface. These videos may be pre-designed for various features or aspects on the web service interface and when the user encounters these specifically designated areas, launching or displaying of the videos can provide an additional level of user interactivity.

Another embodiment, relative to the system of FIGS. 1a and 1b may include the processing device operative to access a web assistant manager via a networked connection and retrieve the first interface from the web assistant manager. This embodiment may include the first interface being centrally stored and retrievable upon usage by the user's computing device.

An additional embodiment includes additional processing operations including monitoring user activities on the web services to generate activity logs and providing the activity logs to a system administrator. For example, in FIG. 1a, the web assistant manager 116 may receive feedback information from monitoring applications local on the user computing devices or resident on the web service servers. This embodiment allows for the tracking of information and subsequent incremental building of additional knowledge on the effectiveness of the first interface, as well as determining benefits with the web services themselves.

Another embodiment includes the bypassing operation, e.g. see step 408 of FIG. 4, further including the automatic generation of alternative web service user names if the required user name is already in use. For example, many sites may require the user to select a login name and the user may try to use the same login for as many sites as possible to maintain consistency. If the login is unavailable, for example someone has already used it, an alternative name may be automatically chosen, such as for example including additional characters to the name.

Another embodiment includes the bypassing operation, e.g. see step 408 of FIG. 4, further including automatically confirming registration requests by receiving a confirmation email and following the confirmation link within. It is not uncommon for websites to seek verification of user registration by withhold full registration/login until a confirmatory email has been received and processed. This can typically include the user selecting an embedded hyperlink to verify the user's email address matches the user's identity. In this embodiment, this may be automatically performed including operations to open, scan and activate the detected hyperlink.

Another embodiment may include processing operations to remember a user's favorite starting page within a web site and automatically browsing to that page when the site is first visited. Typically, a user visits a welcome or home page and must navigate to the desired page, but the navigation sequence or sub-page can be noted by the processing device on the sub-page automatically presented to the user upon returning to the web service or upon successful completion of a login activity.

Another embodiment may include back-end processing operations to translate relevant information in a web site from a foreign language to a native language. Another technique can include chaining common web site actions such that they will be initiated via a single new action. The new action may include performing multiple actions on a single web site, performing multiple actions on multiple web sites or a series of related actions across multiple web sites. One example of a common action may be logging into to numerous web sites with a single action. In another example, a user may like to link or attach a number of articles in a single email.

Another embodiment allows further central control for the user through the first interface. For example, the user may be able to manage multiple web sites through a central location, such as through the interface. This embodiment may include programming functionality whereby various aspects to the various web sites can be actively managed, such as the example of managing really simple subscription (RSS) feeds, managing notification techniques such as the example of updating an email address or other contact information.

Through the above-described embodiments, the user is provided through a system and method for guiding the user to operate simplified computing operations for common web service activities. Other aspects would become apparent to those skilled in the relevant art(s) in view of the teachings of the present disclosure. FIGS. 1-4 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of the invention as described herein. In this document, the terms “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computer-implemented method for guiding a user to operate simplified computing operations for common web services activities via a web service interface standard to the web service itself, the method comprising:
recognizing a user's activity with the web service;
providing a first interface to the user for performing an operation relating to the web service, where the first interface is different from the web service interface associated with the web service and the first interface includes a plurality of graphical elements;
receiving user input commands via the first interface;
translating the user input commands into a format usable by the web service;
providing the translated input commands to the web service to bypass existing web service input commands provided by the web service interface;
receiving an output from the web service in response to the translated input commands; and
translating the output for display via the first interface.

2. The computer-implemented method of claim 1 further comprising:
recognizing at least one repetitive input command to the web service interface;
translating input information for a generalized input command usable with the first interface; and
via the first interface, providing the generalized input command in place of the repetitive input command.

3. The method of claim 1, wherein the first interface include darkening portions of an overlay directly over the web service interface such that the un-darkened portions illustrate selectable interface components to be selected by the user.

4. The method of claim 1, wherein the first interface includes displaying a new selectable visual component for user selection instead of the existing visual component in the web service interface.

5. The method of claim 1, wherein the first interface includes a graphical overlay of one or more video elements providing direct visual instructions for the user to perform steps for interacting with the underlying web service interface.

6. The method of claim 1 further comprising:
accessing a web assistant manager via a networked connection; and
retrieving the first interface from the web assistant manager.

7. The method of claim 1 further comprising:
monitoring the user activities on the web services to generate activity logs; and
providing the activity logs to a system administrator.

8. The method of claim 1 wherein the bypassing includes automatic generation of alternative web service user names if the required user name is already in use.

9. The method of claim 1 wherein the bypassing includes automatically confirming registration requests by receiving a confirmation email and following the confirmation link within.

10. The method of claim 1 further comprising:
remembering a user's favorite starting page within a web site; and
automatically browsing to that page when the site is first visited.

11. The method of claim further comprising:
translating relevant information in a web site from a foreign language to a native language.

12. The method of claim 1 further comprising:
enabling the chaining of common website actions such that they will be initiated via a single new action.

13. The method of claim 12, wherein the new action includes at least one of:
performing multiple actions on a single web site, performing multiple actions on multiple web sites and a series of related actions across multiple web sites.

14. The method of claim 1 further comprising:
allowing a user to actively manage a plurality of web site accounts at a single location.

15. A system for guiding a user to operate simplified computing operations for common web services activities via a web service interface standard to the web service itself, the system comprising:
a computer readable medium having executable instructions stored thereon; and
a processing device, in response to the executable instructions, operative to:
recognize a user's activity with the web service;
provide a first interface to the user for performing an operation relating to the web service, where the first interface is different from the web service interface associated with the web service and the first interface includes a plurality of graphical elements;
receive user input commands via the first interface;
translate the user input commands into a format usable by the web service;
provide the translated input commands to the web service to bypass existing web service input commands provided by the web service interface;
receive an output from the web service in response to the translated input commands; and
translate the output for display via the first interface.

16. The system of claim 15, in response to further executable instructions, the processing device further operative to:
recognize at least one repetitive input command to the web service interface;
translate input information for a generalized input command usable with the first interface; and
via the first interface, provide the generalized input command in place of the repetitive input command.

17. The system of claim 15, wherein the first interface include darkening portions of an overlay directly over the web service interface such that the un-darkened portions illustrate selectable interface components to be selected by the user.

18. The system of claim 15, wherein the first interface includes displaying a new selectable visual component for user selection instead of the existing visual component in the web service interface.

19. The system of claim 15, wherein the first interface includes a graphical overlay of one or more video elements providing direct visual instructions for the user to perform steps for interacting with the underlying web service interface.

20. The system of claim 15 further comprising:
accessing a web assistant manager via a networked connection; and
retrieving the first interface from the web assistant manager.

21. The system of claim 15 further comprising:
monitoring the user activities on the web services to generate activity logs; and
providing the activity logs to a system administrator.

22. The system of claim 15 wherein the bypassing includes automatic generation of alternative web service user names if the required user name is already in use.

23. The system of claim 15 wherein the bypassing includes automatically confirming registration requests by receiving a confirmation email and following the confirmation link within.

24. The system of claim 15 in response to further executable instructions, the processing device further operative to:
remember a user's favorite starting page within a web site; and
automatically browse to that page when the site is first visited.

25. The system of claim 15 in response to further executable instructions, the processing device further operative to:
translate relevant information in a web site from a foreign language to a native language.

26. The system of claim 15 in response to further executable instructions, the processing device further operative to:
enable the chaining of common website actions such that they will be initiated via a single new action.

27. The system of claim 26, wherein the new action includes at least one of:
performing multiple actions on a single web site, performing multiple actions on multiple web sites and a series of related actions across multiple web sites.

28. The system of claim 15 in response to further executable instructions, the processing device further operative to:
allow a user to actively manage a plurality of web site accounts at a single location.

29. The method of claim 1, wherein the method is performed locally on a processing device.

30. The method of claim 1, wherein the method is performed from a central processing device.

31. The system of claim 15, wherein the processing device is local to the user.

32. The system of claim 15, wherein the processing device is centrally located in a processing network.
